(19) United States
(12) Patent Application Publication
(10) Pub. No.: US 2010/0251185 A1
(43) Pub. Date: Sep. 30, 2010

(54) VIRTUAL OBJECT APPEARANCE CONTROL

(75) Inventor: Robert Mark Pattenden, Southam (GB)

Correspondence Address: Ostrow Kaufman & Frankl LLP;Susan Formicola, The Chrysler Building, 405 Lexington Avenue, 62nd Floor, NEW YORK, NY, 10174, US

(73) Assignee: Codemasters Software Company Ltd., Southam (GB)

(21) Appl. No.: 12/415,238

(22) Filed: Mar. 31, 2009

(51) Int. Cl. G06F 3/048

(52) U.S. Cl. 715/849

(57) ABSTRACT

A method of controlling the appearance of an object in a virtual environment of a computer game, in which the computer game is arranged to move the object within the virtual environment, the method comprising: associating with the object a three-dimensional array of nodes by storing, for each node, data defining a position of that node in a coordinate system for the object; defining a first shape of the object by associating each of a first plurality of locations on the object with a respective predetermined position relative to one or more of the nodes; detecting a collision of the object with an item in the virtual environment; adjusting the position of one or more of the nodes to represent the collision, thereby adjusting the first shape of the object; and outputting an image of the object based on the adjusted first shape of the object.

### FIELD OF THE INVENTION

The present invention relates to controlling the appearance of an object in a virtual environment of a computer game.

### BACKGROUND OF THE INVENTION

Computer games and their execution are well-known. Certain computer games involve the movement of one or more virtual objects within a virtual environment of the computer game. For example, in a car-racing genre of computer game, a plurality of virtual cars may be raced around a virtual racing track, with some of these virtual cars being controlled by a computer or games console and others being controlled by a player of the computer game. With such games, it may be desirable to allow one or more of these virtual objects to collide with another one of the virtual objects being moved (e.g. two virtual cars may collide with each other). Similarly, it may be desirable to allow one or more of these virtual objects to collide with an object that is stationary within the virtual environment (e.g. a virtual car may collide with a virtual wall within the virtual environment). As a result of such a collision, the computer game may modify the appearance of the virtual object(s) involved in the collision so as to represent the fact that a collision has occurred.

### SUMMARY OF THE INVENTION

It is an object of the present invention to provide an improvement in the way in which the appearance of an object is adjusted when it has been involved in a collision with an item in a virtual environment.

According to a first aspect of the invention, there is provided a method of controlling the appearance of an object in a virtual environment of a computer game, in which the computer game is arranged to move the object within the virtual environment, the method comprising: associating with the object a three-dimensional array of nodes by storing, for each node, data defining a position of that node in a coordinate system for the object; defining a first shape of the object by associating each of a first plurality of locations on the object with a respective predetermined position relative to one or more of the nodes; detecting a collision of the object with an item in the virtual environment; adjusting the position of one or more of the nodes to represent the collision, thereby adjusting the first shape of the object; and outputting an image of the object based on the adjusted first shape of the object.

In this way, embodiments of the invention provide a method of transforming the appearance of an object from a pre-collision appearance to a post-collision appearance in a flexible and versatile manner.

In some embodiments, the first plurality of locations on the object are vertices of respective triangles that define a surface of the object.

In some embodiments, the method comprises defining a second shape of the object by associating each of a second plurality of locations on the object with a respective predetermined position relative to one or more of the nodes; wherein detecting a collision of the object with an item comprises detecting that one or more of the second plurality of locations lies within the item.

The second plurality of locations may have fewer locations than the first plurality of locations.

In some embodiments, adjusting the position of one or more of the nodes to represent the collision comprises simulating applying one or more respective forces at the one or more of the second plurality of locations that lie within the item. Some embodiments then comprise storing rigidity data representing a degree of elasticity between the nodes; and calculating the one or more forces based, at least in part, on the rigidity data. Additionally, some embodiments may then comprise determining, for each of the one or more of the second plurality of locations that lie within the item, a respective depth that that location is within the item, wherein calculating the one or more forces is based, at least in part, on the respective depths. Moreover, some embodiments may then comprise, for at least one of the one or more of the second plurality of locations that lie within the item, setting the respective depth for that location to a predetermined threshold depth associated with that location if the determined depth exceeds that threshold depth.

In some embodiment, the method comprises determining the one or more forces based, at least in part, on a relative speed between the object and the item.

Some embodiments comprise defining a second shape of the object by associating each of a second plurality of locations on the object with a respective predetermined position relative to one or more of the nodes, such that adjusting the position of one or more of the nodes to represent the collision results in adjusting the second shape of the object; detecting whether, as a result of adjusting the position of one or more of the nodes to represent the collision, a predetermined one of the first plurality of locations has been displaced by more than a threshold distance; and if that predetermined one of the first plurality of locations has been displaced by more than the threshold distance, then outputting the image of the object based on the adjusted second shape of the object instead of the adjusted first shape of the object.

Some embodiments comprise associating with each of the nodes a respective texture value representing a degree of texture for that node; wherein outputting the image of the object comprises applying a texture to a surface of the object based on the texture values.

According to a second aspect of the invention, there is provided a method of executing a computer game, the method comprising carrying out the method of the above-mentioned first aspect of the invention at each time point of a first sequence of time points.

In some embodiments, the method comprises, after the collision has been detected, displaying a sequence of images of the object, each image corresponding to a respective time point of a second sequence of time points, the time difference between successive time points of the second sequence of time points being smaller than the time difference between successive time points of the first sequence of time points, by: determining a point in time at which the collision occurred; for each time point of the second sequence of time points that precedes the determined point in time, using the positions of the nodes prior to the collision to determine a shape of the object for display; for each time point of the second sequence of time points between the determined point in time and the time point of the first sequence of time points at which the collision is detected, interpolating between the positions of the nodes prior to the collision and the adjusted positions of the nodes to determine intermediate positions of the nodes to determine a respective shape of the object for display.

According to a third aspect of the invention, there is provided an apparatus arranged to execute a computer game and control the appearance of an object in a virtual environment of the computer game, in which the computer game is arranged to move the object within the virtual environment, the apparatus comprising: a memory storing: (a) data associating with the object a three-dimensional array of nodes, the data comprising, for each node, data defining a position of that node in a coordinate system for the object; and (b) data defining a first shape of the object by associating each of a first plurality of locations on the object with a respective predetermined position relative to one or more of the nodes; and a processor comprising: a collision detection module for detecting a collision of the object with an item in the virtual environment; an adjustment module for adjusting the position of one or more of the nodes to represent the collision, thereby adjusting the first shape of the object; and an image output module for outputting an image of the object based on the adjusted first shape of the object.

According to a fourth aspect of the invention, there is provided a computer readable medium storing a computer program which, when executed by a computer, carries out a method according to the above first aspect of the invention.

### BRIEF DESCRIPTION OF THE DRAWINGS

Embodiments of the invention will now be described, by way of example only, with reference to the accompanying drawings, in which:

FIG. 1 schematically illustrates a games system according to an embodiment of the invention;

FIG. 2 schematically illustrates the data and modules used for carrying out an embodiment of the invention during execution of a computer game;

FIG. 3a schematically illustrates an example deformation mesh;

FIG. 3b schematically illustrates a deformation mesh;

FIG. 4a schematically illustrates the location of a triangle relative to a portion of a deformation mesh;

FIG. 4b schematically illustrates a two-dimensional version of FIG. 4a;

FIG. 4c schematically illustrates a version of FIG. 4b in which the relative positions of the nodes of the deformation mesh have been updated;

FIG. 5 is a flowchart schematically illustrating the processing involved in a method of executing a computer game according to an embodiment of the invention;

FIG. 6 schematically illustrates a collision and the processing performed by a collision detection module;

FIG. 7 is a flowchart schematically illustrating a method for updating the appearance of an object once a collision has been detected;

FIG. 8a schematically illustrates a part of a deformation mesh and two triangles of graphical data and their respective vertices; and

FIG. 8b schematically illustrates the same part of the deformation mesh of FIG. 8a after the deformation mesh has undergone a deformation.

### DETAILED DESCRIPTION OF EMBODIMENTS OF THE INVENTION

In the description that follows and in the figures, certain embodiments of the invention are described. However, it will be appreciated that the invention is not limited to the embodiments that are described and that some embodiments may not include all of the features that are described below. It will be evident, however, that various modifications and changes may be made herein without departing from the broader spirit and scope of the invention as set forth in the appended claims.

Embodiments of the invention relate to computer games in which one or more virtual objects are located within a virtual environment of, and provided by, the computer game. The term “virtual environment” means a simulation or representation of a part of a real physical, or an imaginary, universe, world, space, place, location or area, i.e. the virtual environment represents and provides a computer-generated arena in which the game is to be played. The term “virtual object” then refers to a simulation or representation of an object, person, animal, vehicle, item or article present and located within the simulated arena of the virtual environment.

The computer game is arranged to move one or more objects within the virtual environment. In such games, a games console executing the computer game may automatically determine and control the movement of one or more of the virtual objects within the virtual environment, e.g. in terms of the path (route or course), speed (or velocity), acceleration, etc. of those objects. These objects may be referred to as computer-controlled objects (although they may also be referred to as Artificial Intelligence (AI) objects or robot objects), as their movement is not directly controlled by a user or player of the game. Additionally, one or more users may be responsible for (directly) controlling the movement of one or more other virtual objects within the virtual environment, e.g. by providing input to the games console via one or more game controllers. Such objects shall be referred to as player-controlled objects.

For example:
The virtual environment could represent one or more buildings (which may be fictitious) and the virtual objects could comprise computer-controlled objects representing enemy soldiers that are to be moved within and around the simulated buildings, as well as a player-controlled object representing a player's character.
The virtual environment could represent space (with planets, stars, etc.) and the virtual objects could comprise computer-controlled objects representing spacecraft and meteors that are to be moved within the virtual environment, as well as a player-controlled object representing a player's spaceship.
The virtual environment could represent an ocean or other body of water (or the air), and the virtual objects could represent objects such as fish, boats, submarines etc. (or birds, aeroplanes and helicopters etc.).
The virtual environment could represent a racing course (or track) and the virtual objects may comprise computer-controlled and player-controlled objects representing objects to be raced along the race course. The race course could be a racing course for vehicles (such as cars, trucks, lorries, motorcycles, aeroplanes, etc.), with the virtual objects then representing cars, trucks, lorries, motorcycles, aeroplanes, etc. accordingly. Alternatively, the racing course could be a racing course for animals (such as horses or dogs), with the objects then representing the corresponding animal.

As the objects (computer-controlled and/or player-controlled objects) move in the virtual environment, they may collide with each other in the virtual environment, or they may collide with objects or items present in the virtual environment that are stationary in the virtual environment (such as simulated buildings, barriers, trees, walls, etc.). Two or more objects are deemed to be involved in a “collision” if their extents overlap each other in the virtual environment, i.e. a relative movement of the objects causes a collision if the relative movement causes a point on one of the objects to be inside the shape or volume defined by a surface of another one of the objects.

As a result of the collision, embodiments of the invention may adjust the appearance (in terms of shape and/or colour and/or texture) of one or more of the objects involved in the collision, so as to represent the consequences of the collision. For example, when a simulated vehicle in a vehicle racing game is involved in a collision (e.g. a crash with another vehicle), then an embodiment of the invention may cause the appearance of the vehicle to include one or more dents (i.e. changes in shape) and/or one or more scratches (i.e. changes in colour and/or texture). Embodiments of the invention therefore provide a method of controlling the appearance of an object in a virtual environment of a computer game, in which the computer game is arranged to move the object within the virtual environment, in particular controlling the object's appearance once a collision of the object with another item in the virtual environment has been detected.

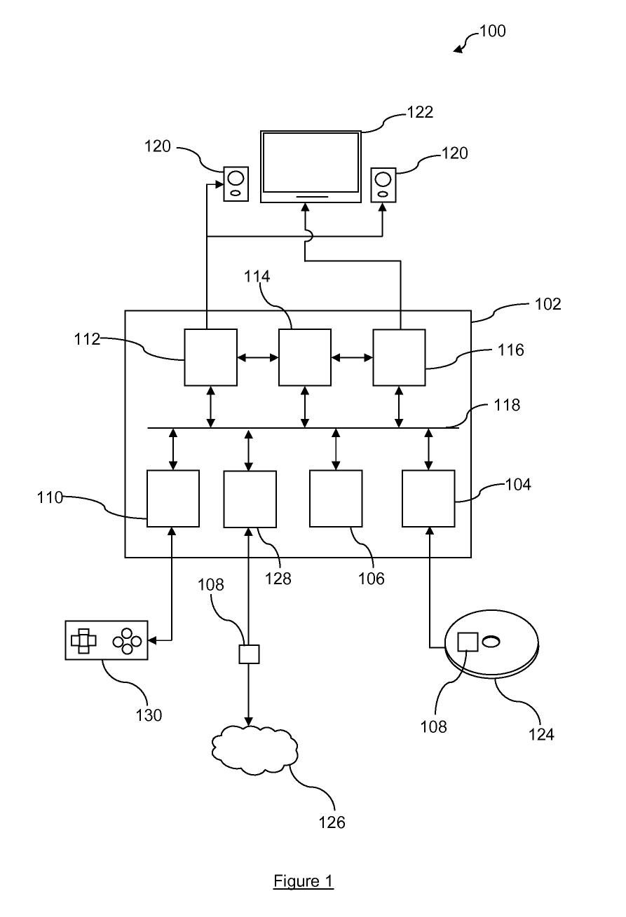

FIG. 1 schematically illustrates a games system 100 according to an embodiment of the invention. The games system 100 comprises a games console 102 that is arranged to execute and provide a computer game 108 to a user (player), so that a user of the games system 100 can play the game. The games system 100 also comprises a number of peripheral devices, such as a controller 130, a display (screen or monitor) 122 and one or more speakers 120, with which the games console 102 may interface and communicate to facilitate execution and operation of the computer game 108.

The games console 102 comprises: a media interface 104, a processor 106, a network interface 128, a controller interface 110, an audio processing unit 112, a memory 114 and a graphics processing unit 116, which may communicate with each other via a bus 118. Additionally, the audio processing unit 112 and the graphics processing unit 116 may read data from, and store (or write) data to, the memory 114 directly, i.e. without having to use the bus 118, in order to improve the data access rate.

The media interface 104 is arranged to read data from one or more storage media 124, which may be removable storage media such as a CD-ROM, a DVD-ROM, a Blu-Ray disc, a FLASH memory device, etc. In particular, the media interface 104 may read one or more computer games 108 or computer programs that are stored on the storage medium 124. The media interface 104 may also read other data, such as music or video files (not shown) that may be stored on the storage medium 124. The computer game 108, programs and other data read from the storage medium 124 may be stored in the memory 114 or may be communicated via the bus 118 directly to one or more of the elements of the games console 102 for use by those elements. The media interface 104 may perform these operations automatically itself, or it may perform these operations when instructed to do so by one of the elements of the games console 102 (e.g. the audio processing unit 112 may instruct the media interface 104 to read audio data from the storage medium 124 when the audio processing unit 112 requires certain audio data).

The network interface 128 is arranged to receive (download) and/or send (upload) data across a network 126. In particular the network interface 128 may send and/or receive data so that the games console 102 can execute and provide a computer game 108 to a user of the games system 100. The games console 102 may be arranged to use the network interface 128 to download the computer game 108 via the network 126 (e.g. from a games distributor, not shown in FIG. 1). Additionally or alternatively, the games console may be arranged to use the network interface 128 to communicate data with one or more other games consoles 102 that are also coupled to the network 126 in order to allow the users of these games consoles 102 to play a game with (or against) each other. The computer game 108, programs and other data downloaded from the network 110 may be stored in the memory 114 or may be communicated via the bus 118 directly to one or more of the elements of the games console 102 for use by those elements. The network interface 128 may perform these operations automatically itself, or it may perform these operations when instructed to do so by one of the elements of the games console 102.

The processor 106 and/or the audio processing unit 112 and/or the graphics processing unit 116 may execute one or more computer programs of the computer game 108 in order to provide the game to the user. The processor 106 may be any processor suitable for carrying out embodiments of the invention. To do this, the processor 106 may cooperate with the audio processing unit 112 and the graphics processing unit 116. The audio processing unit 112 is a processor specifically designed and optimised for processing audio data. The audio processing unit 112 may read audio data (e.g. from the memory 114) or may generate audio data itself, and may then provide a corresponding audio output signal (e.g. with sound effects, music, speech, etc.) to the one or more speakers 120 to provide an audio output to the user. Similarly, the graphics processing unit 116 is a processor specifically designed and optimised for processing video (or image) data. The graphics processing unit 116 may read image/video data (e.g. from the memory 114), or may generate image/video data itself, and may then provide a corresponding video output signal (e.g. a series of video fields or frames according to a video format) to the display unit 122 to provide a visual output to the user.

While the speakers 120 are shown as being separate from the display unit 122 in FIG. 1, it will be appreciated that the speakers 120 may be integral with the display unit 122. Additionally, whilst the speakers 120 and the display unit 122 are shown as being separate from the games console 102 in FIG. 1, it will be appreciated that the speakers 120 and/or the display unit 122 may be integral with the games console 102.

The user may interact with the games console 102 using one or more game controllers 130. A variety of game controllers are known and available, and they shall not be described in detail herein. The controller interface 110 is arranged to receive input signals from the game controller 130, these signals being generated by the game controller 130 based on how the user interacts with the game controller 130 (e.g. by pressing buttons on, or moving, the game controller 130). The controller interface 110 passes these input signals to the processor 106 so that the processor 106 can coordinate and provide the game in accordance with the commands issued by the user via the game controller 130. Additionally, the controller interface 110 may provide output signals to the game controller 130 (e.g. to instruct the game controller 130 to output a sound or to vibrate) based on instructions received by the controller interface 110 from the processor 106.

While the game controller 130 is shown as being separate from the games console 102 in FIG. 1, it will be appreciated that the game controller 130 may be integral with the games console 102.

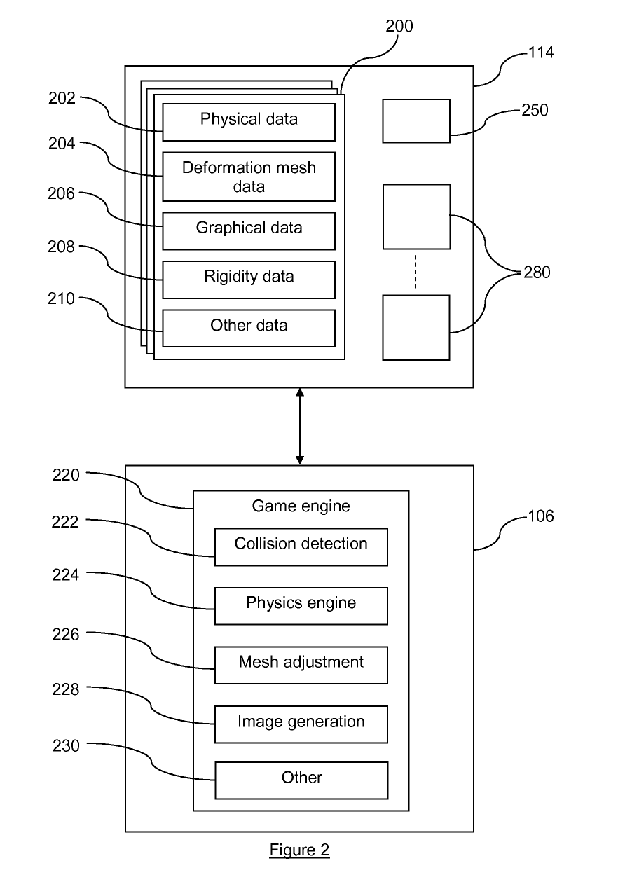

FIG. 2 schematically illustrates the data and modules used for carrying out an embodiment of the invention during execution of the computer game 108.

For each of the computer-controlled and player-controlled objects, the memory 114 stores corresponding game data 200. The game data 200 for an object comprises: physical data 202; deformation mesh data 204; graphical data 206; rigidity data 208; and other data 210. The nature and purpose of the physical data 202, deformation mesh data 204, graphical data 206 and rigidity data 208 shall be described in more detail shortly. The other data 210 forming part of the game data 200 for an object may be any data specific to that object as needed for the execution of the computer game 108. For example, the other data 210 may specify: the position, velocity, acceleration, etc. of the object within the virtual environment; characteristics or attributes of that object; etc.

The memory 114 also stores other data 250 for the computer game 108. This other data 250 may comprise data defining the virtual environment, data defining the current state of play (e.g. score, rankings, etc.), or any other data not specific to a particular object of the computer game 108.

The memory 114 also stores one or more computer programs 280 that form (and are provided by) the computer game 108. These computer programs 280 may be loaded into the memory 114 (e.g. from a storage medium 124) at the beginning of executing the computer game 108. Alternatively, these computer programs 280 may be loaded into the memory 114 only when they are required, and may be removed from the memory 114 when no longer required.

As mentioned above, the processor 106 is arranged to execute the computer programs 280 of the computer game 108. Execution of the computer programs 280 causes the processor 106 to comprise or execute a game engine 220. The game engine 220 itself comprises: a collision detection module 222; a physics engine 224; a mesh adjustment module 226; an image generation module 228; and one or more other program modules 230. The nature and purpose of the collision detection module 222, physics engine 224, mesh adjustment module 226 and image generation module 228 shall be described shortly. The one or more other program modules 230 may comprise logic and/or instructions for carrying out various functions for the computer game 108, such as: generating data representing the virtual environment; maintaining scores; generating sound effects; etc.

The game engine 220 is responsible for the overall operation and execution of the computer game 108. In doing so, the game engine 220 associates with each object to be moved in the virtual environment (player-controlled objects and computer-controlled objects) a so-called “deformation mesh”. As will be become apparent the deformation mesh of an object is used to control the appearance of that object and may be used to help detect when that object has collided with another object.

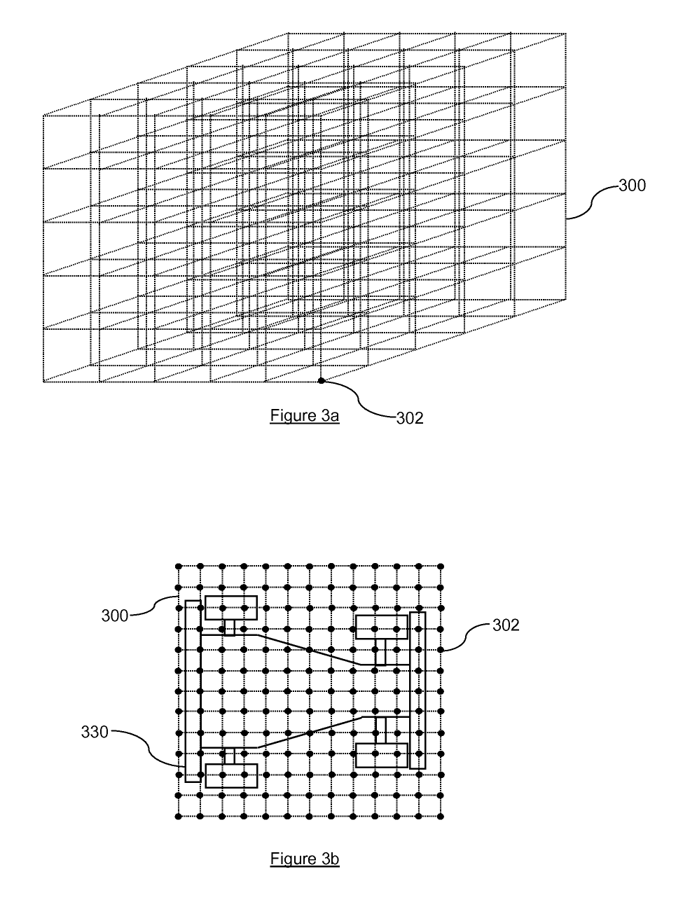

FIG. 3a schematically illustrates an example deformation mesh 300, which is a three-dimensional array (or grid or set or collection or arrangement) of nodes (or points or locations) 302. For clarity, in FIG. 3a only one node 302 is illustrated by the black circle, but it will be appreciated that, in FIG. 3a, a node 302 exists at each intersection of dashed longitudinal, lateral and vertical lines.

It will be appreciated that, whilst the deformation mesh 300 shown in FIG. 3a is a regular array of nodes 302 (i.e. each node 302 is a predetermined distance laterally, longitudinally and vertically away from its neighbouring nodes 302), this need not be the case and that any array of nodes 302 in three dimensions will suffice to form a deformation mesh 300. Indeed, as will be described in more detail later, embodiments of the invention are arranged so as to move one or more of the nodes 302 of the deformation mesh 300 and, in doing so, will disturb the regularity depicted in FIG. 3a.

The deformation mesh 300 associated with an object is based on a coordinate space for that object, i.e. the local coordinate system in which that object is at a fixed location, despite the object potentially being moved within the global coordinate system of the virtual environment. In other words, the local coordinate space of the object may move within the global coordinate space of the virtual environment, with the object being fixed within its local coordinate space. The position and orientation of the local coordinate system for an object relative to the global coordinate system of the virtual environment may be stored as part of the other data 210 of the game data 200 for that object. Thus, the three-dimensional nature of the deformation mesh 300 is in the three-dimensional local coordinate system for that object and the coordinates or position of a node 302 are based on the local coordinate system for the object.

The deformation mesh 300 is sized such that the extent of the object lies entirely within the deformation mesh 300.

For ease of further explanation, the deformation mesh 300 may at some parts of this description be described with reference to two-dimensional drawings. However, it will be appreciated that this is merely for ease of illustration and explanation and that the actual deformation mesh 300 is three-dimensional in the virtual environment of the computer game 108.

FIG. 3b schematically illustrates a deformation mesh 300 of nodes 302 for an object 330. As can be seen, the object 330 is contained within the volume defined by the nodes 302 of the deformation mesh 300, i.e. the object 330 is surrounded by the nodes 302 of the deformation mesh 300.

The deformation mesh data 204 for the object 330, stored in the memory 114 as part of the game data 200 for that object 330, defines the coordinates or position of each node 302 of the deformation mesh 300 for that object 330 in (or with reference to) the local coordinate system of that object 330.

The graphical data 206 for the object 330, stored in the memory 114 as part of the game data 200 for that object 330, comprises data that defines the appearance of the object 330 in terms of a shape of the object 330. The graphical data 206 may also comprise data defining the appearance of the object 330 in terms of the colouring and/or texture of the object 330.

The graphical data 206 for the object 330 defines a shape of the object 330 by a plurality of triangles. The vertices of the triangles are points or locations on the object 330 and the triangles then form or define a surface of the object 330. The plurality of triangles thereby define a shape of the object 330 (or a shape of the surface of the object) by virtue of the positions, orientations, etc. of the triangles for the graphical data 206. The graphical data 206 therefore stores data specifying the respective positions of the vertices of each of these triangles. These vertices shall be referred to as the “vertices of the graphical data 206”.

For each of the triangles, the graphical data 206 stores the position of the three vertices (or points) of that triangle. In particular, for each vertex of each triangle, the graphical data 206 associates that vertex with a predetermined position relative to one or more of the nodes 302 of the deformation mesh 300.

Similarly, the colours and textures of the plurality of triangles define the colouring and texture of the object 330 (or at least the surface of the object 330). The graphical data 206 may therefore store data specifying a respective colouring and/or texture for each of these triangles.

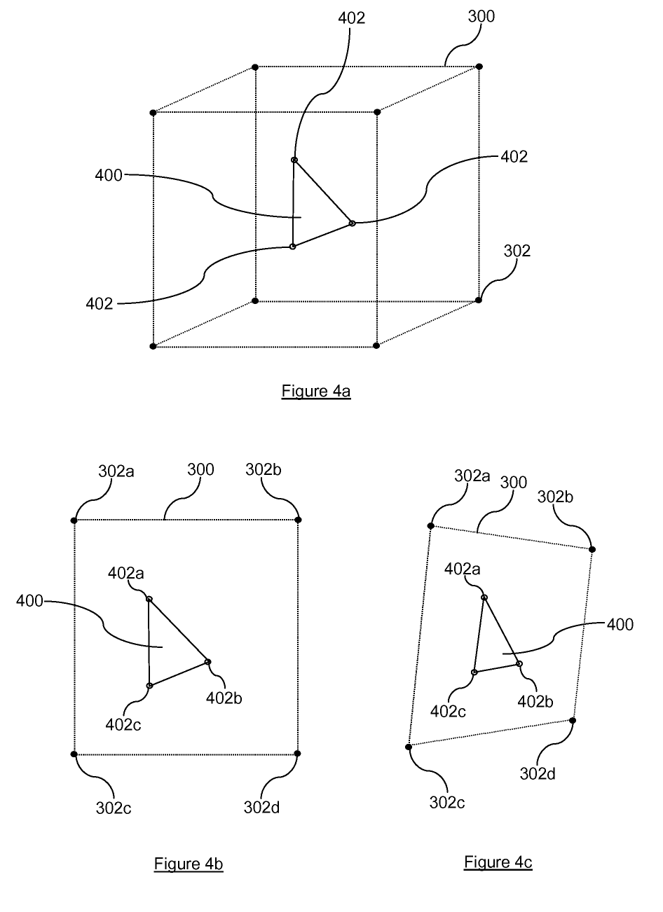

FIG. 4a schematically illustrates the location of a triangle 400 relative to a portion of the deformation mesh 300. Only one triangle 400 is shown in FIG. 4a for clarity, but it will be appreciated that embodiments of the invention make use of a plurality of triangles to define a shape of the object 330. In FIG. 4a, the three vertices 402 of the triangle 400 are all shown to be within the volume defined by the same eight nearest nodes 302 of the deformation mesh 300. However, it will be appreciated that each vertex 402 may have respectively different nearest nodes 302 of the deformation mesh 300. The graphical data 206 therefore comprises, for each vertex 402, data defining the predetermined position of that vertex with respect to the eight nearest nodes 302 of the deformation mesh 300.

FIG. 4b schematically illustrates a two-dimensional version of FIG. 4a (although again it will be appreciated that the deformation mesh 300 and the triangles 400 are in the three dimensional local coordinate system of the object 330). As will be described later, the position of the nodes 302 of the deformation mesh 300 may be adjusted (e.g. to represent that the object 330 has been involved in a collision). FIG. 4c schematically illustrates a version of FIG. 4b in which the relative positions of the nodes 302 of the deformation mesh 300 in the local coordinate space of the object 330 have been updated. As mentioned, the graphical data 206 stores data associating each vertex 402a, 402b, 402c of the triangle 400 with a predetermined position relative to one or more of the nodes 302a, 302b, 302c, 302d of the deformation mesh 300, as opposed to a predetermined position in the local coordinate space of the object 330. Thus, the relative position of each vertex 402a, 402b, 402c with respect to the nodes 302a, 302b, 302c, 302d is the same in FIG. 4b (before the deformation of the deformation mesh 300) as it is in FIG. 4c (after the deformation of the deformation mesh 300). The consequence of this is that adjusting the position of (or moving or updating) one or more of the nodes 302a, 302b, 302c, 302d in the local coordinate space of the object 330 causes a corresponding update of the position of the vertices 402a, 402b, 402c within the local coordinate space of the object 330, whilst the vertices 402a, 402b, 402c still maintain their predetermined positions relative to one or more of the nodes 302a, 302b, 302c, 302d of the deformation mesh 300.

For example, in FIG. 4b, the node 302a is directly above the node 302c, and the vertex 402a is directly above the vertex 402c. The deformation of the deformation mesh 300 to transform from FIG. 4b to FIG. 4c has caused the node 302a to no longer be directly above the node 302c—rather it is above and to the right of the node 302c. In turn, this has caused the vertex 402a to no longer be directly above the vertex 402c—rather, it is now above and to the right of the vertex 402c. However, the relative positions of the vertices 402a, 402c with respect to the nodes 302a, 302c (as defined by the graphical data 206) are the same in FIGS. 4b and 4c.

In this way, deforming the deformation mesh 300 (i.e. moving, or updating or adjusting or changing the position of, the nodes 302 of the deformation mesh 300) causes the shape of the object 330 to be changed, as the location of the vertices 402 of the triangles 400 in the local coordinate system of the object 330 will thereby change to reflect the deformation of the deformation mesh 300.

To achieve this, in one embodiment, the graphical data 206 stores, for each vertex 402 of each triangle 400, coordinates for that vertex 402 in the local coordinate space for the object 330. These coordinates are the coordinates of the vertex 402 before any deformation of the deformation mesh 300 has taken place (i.e. the original, non-deformed position of that vertex 402). Then, during execution of the computer game, the game engine 220 may determine the one or more nearest neighbouring nodes 302 of the deformation mesh 300 for that vertex 402. For example, within the initially regular deformation mesh 300 shown in FIG. 3a, it is relatively straightforward to determine which eight nodes 302 form a cube containing the vertex 402 whose coordinates are specified by the graphical data 206. The game engine 220 may also determine the proportion of the length of the cube along each of the three axes of the cube that the vertex 402 is positioned at within that cube. If the deformation mesh 300 has been deformed or altered, then the game engine 220 may still identify, for a vertex 402, the same nearest neighbouring nodes 302 and the above-mentioned proportions based on the initial undeformed deformation mesh 300, and it may then use these proportions together with the updated positions of the identified nodes 302 to determine an updated position to use for that vertex 402, e.g. the game engine 220 may use linear interpolation of the updated positions of the identified nodes 302 based on the determined proportions. In this way, each of the vertices 402 of the graphical data 206 is a location on the object 330 with a respective predetermined position relative to one or more of the nodes 302 of the deformation mesh 300 and, in this way, a first shape of the object is defined by associating each of a first plurality of locations (the vertices 402 of the graphical data 206) on the object 330 with a respective predetermined position relative to one or more of the nodes 302.

For example:
Consider a deformation mesh 300 for which the deformation mesh data 206 stores data identifying the initial coordinates of the nodes 302 as (x, y, z), where x=0,1, . . . , 10, y−0,1, . . . 10 and z=0,1, . . . , 10, so that there are 1331 nodes 302 regularly spaced as shown in part in FIG. 3a.
The graphical data 206 may store the initial (undeformed) coordinates of a vertex 402 of a triangle 400 as (8.3,4.2,1.9).
The game engine 220 may therefore determine that the eight nearest neighbouring nodes 302 for that vertex 402 are: (8,4,1), (8,4,2), (8,5,1), (8,5,2), (9,4,1), (9,4,2), (9,5,1), (9,5,2). The vertex 402 lies within the cube defined by these eight nodes 302.
The lengths of the sides of the cube along each of the x-, y- and z-axes is 1 (due to the initial regular spacing of the nodes 302). The game engine 220 may therefore determine that that vertex 402 is positioned (8.3−8)/1=0.3 of the length of the cube along the x-axis within the cube; that vertex 402 is positioned (4.2−4)/1=0.2 of the length of the cube along the y-axis within the cube; and that vertex 402 is positioned (1.9−1)/1=0.9 of the length of the cube along the z-axis within the cube.
If, during execution of the game, the deformation mesh 300 has been changed, so that the deformation mesh data 206 has been updated, then the game engine 220 may still refer to the original (undeformed) position of the nodes 302 of the deformation mesh 300 to identify the same nodes 302 and the same proportions as above for the vertex 402.
The deformation mesh data 206 for these nodes 302 may have changed respectively to, for example: (6.91,3.41,1.31), (6.82,3.42,2.52), (7.00,4.50,1.20), (6.92,4.62,2.62), (8.01,3.52,1.22), (8.21,3.51,2.49), (8.11,4.51,1.21), (8.13,4.63,2.53).
The game engine 220 may then use an alternative (updated) x-coordinate for the vertex 402 due to the deformation of the deformation mesh 300. This alternative x-coordinate is calculated via interpolation of the x-coordinates of the above-identified nodes 302, based on the above-identified proportions. In particular, the re-calculated adjusted x-coordinate is:

(1−0.3)×(1−0.2)×(1−0.9)×6.91+(1−0.3)×(1−0.2)×0.9×6.82+(1−0.3)×0.2×(1−0.9)×7.00+(1−0.3)×0.2×0.9×6.92+0.3×(1−0.2)×(1−0.9)×8.01+0.3×(1−0.2)×0.9×8.21+0.3×0.2×(1−0.9)×8.11+0.3×0.2×0.9×8.13≅7.25
Similarly, an interpolated adjusted y-coordinate for the vertex is:

(1−0.3)×(1−0.2)×(1−0.9)×3.41+(1−0.3)×(1−0.2)×0.9×3.42+(1−0.3)×0.2×(1−0.9)'4.50+(1−0.3)×0.2'0.9×4.62+0.3×(1−0.2)×(1−0.9)×3.52+0.3×(1−0.2)×0.9×3.51+0.3×0.2×(1−0.9)×4.51+0.3×0.2×0.9×4.63≅3.68

and an interpolated adjusted z-coordinate for the vertex is:

(1−0.3)×(1−0.2)×(1−0.9)×1.31+(1−0.3)×(1−0.2)×0.9×2.52'(1−0.3)×0.2×(1−0.9)×1.20+(1−0.3)×0.2×0.9×2.62+0.3×(1−0.2)×(1−0.9)×1.22+0.3×(1−0.2)×0.9×2.49+0.3×0.2×(1−0.9)×1.21+0.3×0.2×0.9×2.53≅2.40
In this way, the game engine 220 may ascertain an updated position for the vertex 402 due to the deformation of the deformation mesh 300. However, this updated position of the vertex 402 is still at the same predetermined position relative to the eight nearest neighbouring nodes as it was when the deformation mesh 300 was not deformed.

It will be appreciated that the above example is merely explanatory and, in particular: (a) the initial deformation mesh 300 may have nodes 302 positioned at different locations and may have fewer or greater numbers of nodes 302; (b) the position of the vertex 402 is merely exemplary and the above calculations apply analogously to other vertex positions; (c) the graphical data 206 could store, instead, for each vertex 402 identifiers of the nearest neighbouring nodes 302 and/or the above-mentioned proportions—whilst this may increase the amount of data to be stored, this would result in reduced processing for the game engine 220 during runtime; (d) other interpolation methods may be used to ensure that the location used for a vertex 402 is at the same predetermined position relative to one or more of the nodes 302 of the deformation mesh 300.

Similarly, the physical data 202 for the object 330, stored in the memory 114 as part of the game data 200 for that object 330, comprises data that defines a shape (or an extent) of the object 330. This is done in the same way in which the graphical data 206 defines a shape for the object 330, namely the physical data 202 for the object 330 defines a shape of the object 330 by a plurality of triangles. The vertices of the triangles are points or locations on the object 330 and the triangles then form or define a surface of the object 330. The plurality of triangles thereby define a shape of the object (or a shape of the surface of the object) by virtue of the positions, orientations, etc. of the triangles used for the physical data 202. The physical data 202 therefore stores data specifying the positions of the vertices of each of these triangles in the same way as for the graphical data 202, i.e. for each vertex of each triangle used for the physical data 202, the physical data 202 associates that vertex with a predetermined position relative to one or more of the nodes 302 of the deformation mesh 300. These vertices shall be referred to as the “vertices of the physical data 202”.

However, the number of triangles (and hence vertices) associated with the physical data 202 is typically less than the number of triangles (and hence vertices) associated with the graphical data 206. In this way, the physical data 202 defines a coarser (i.e. less detailed and less refined) shape for the object 330 than the shape defined by the graphical data 206. In particular, the shape for the object 330 defined by the physical data 202 may be considered to be an approximation of the shape for the object 330 defined by the graphical data 206. The triangles for the physical data 202 may therefore be larger in general than the triangles for the graphical data 206, i.e. the vertices of the physical data 202 are more spread out (i.e. are less dense) than the vertices of the graphical data 206.

For example, in a car racing game in which the object 330 represents a car, the graphical data 206 for that car may have data for the vertices of 30000 triangles to define in detail a shape and appearance of that car, whilst the physical data 202 for that car may have data for the vertices of only 400 triangles to define a more approximate, rougher shape for that car.

The reason for using both the graphical data 206 and the physical data 202 to define respective shapes for an object 330 is as follows. As will be described in more detail later, the graphical data 206 is used when generating an output image for display to the user, where the output image will include an image or visual representation of the whole or part of the object 330. In contrast, as will be described in detail later, the physical data 202 is used to determine when the object 330 has collided with (or hit or impacted on) another object, which can be computationally intensive, but this does not need as accurate data in comparison to when generating an image of the object 330. Hence, a large number of triangles are used for the graphical data 206 to ensure that a high quality image is generated and output, whereas fewer triangles may be used for the physical data 202 to ensure that the collision detection is not too computationally intensive, which is possible as the computations need not necessarily be as accurate as when producing and rendering an image of the object 330.

In some embodiments, however, the physical data 202 and the graphical data 206 are combined together (so that only one set of data in then used). This reduces the amount of data that needs to be stored in the memory 114.

As mentioned above, embodiments of the invention are arranged to deform (or update or adjust or change) the deformation mesh 300. This is done by moving one or more of the nodes 302 of the deformation mesh 300 within the local coordinate system for the object 330 (i.e. updating the deformation mesh data 206 to reflect these changes). As will be described later, embodiments of the invention achieve this by simulating the application of one or more forces to one or more points located within the volume of the deformation mesh 300.

The rigidity data 208 for an object 330, stored in the memory 114 as part of the game data 200 for that object 330, comprises data that defines, for each pair of adjacent nodes 302 in the deformation mesh 300 for that object 330, a corresponding measure of the rigidity (or compressibility, deformability, flexibility, or resilience) of a (imaginary) link between those adjacent nodes 302. This measure of rigidity is a measure of how far those two nodes would move towards or away from each other in dependence on the size and direction of a force applied to one or both of those nodes. In essence, the rigidity data 208 for a pair of adjacent nodes 302 simulates a spring (or elastic member) connecting those adjacent nodes, where the rigidity data 208 specifies the degree of elasticity of that spring.

In this way, the deformation mesh 300, when considered as being defined by both the deformation mesh data 204 and the rigidity data 208, may be considered as an array of nodes 302 (whose positions are specified by the deformation mesh data 204) where adjacent nodes 302 are linked together by (imaginary) elastic members (whose respective elasticities are specified by the rigidity data 208).

In essence, then, the rigidity data 208 defines a degree of elasticity between the nodes 302 of the deformation mesh 300 so that it is possible to determine how the nodes 302 will move (i.e. what distance and in what direction) if one or more forces are applied at various locations within the volume of the deformation mesh 300 (if, for example, the deformation mesh 300 were considered as a flexible solid, such as a sponge or a jelly).

Allowing different parts or sections of the deformation mesh 300 to have different rigidities (as specified by the rigidity data 208) allows the game data 200 to stipulate regions of different hardness or softness or firmness for the object 330, so that these regions may then behave differently when involved in a collision.

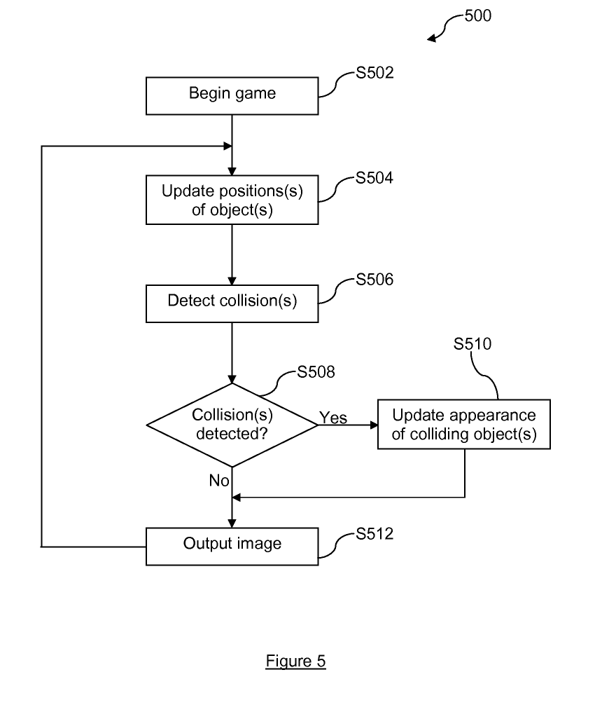

FIG. 5 is a flowchart schematically illustrating the processing involved in a method 500 of executing the computer game 108 according to an embodiment of the invention. It will be appreciated that various functionality of the computer game 108 (such as background music output, scoring, etc.) is not illustrated in FIG. 5—rather, FIG. 5 simply illustrates the steps relevant to embodiments of the invention.

At a step S502, execution of the computer game 108 (or at least a current turn in the computer game 108) commences. At the step S502, the game engine 220 initialises the respective deformation meshes 300 associated with the various objects 330 in the virtual environment of the computer game 108. For example, the game engine 220 may initialise the deformation meshes 300 so that they are regular grids 300 of nodes 302 as illustrated in figures 3a and 3b. The deformation mesh data 204 for an object 330 is therefore set to represent the initialised deformation mesh 300 of that object 330.

At a step S504, the position of one or more of the objects within the virtual environment is updated. For a player-controlled object, the positional update may result at least in part from one or more inputs from the player controlling that object, and may result, at least in part, from decisions made by the game engine 220. For a computer-controlled object, the positional update results from decisions made by the game engine 220 (e.g. artificial intelligence of the computer game 108 deciding how to control a car in a car racing game). Such object movement is well known and shall not be described in detail herein.

At a step S506, the collision detection module 222 determines whether any of the objects have been involved in a collision. A collision may involve two or more of the objects that have been moved impacting on each other. However, a collision may involve a single object that has been moved impacting on a stationary object within the virtual environment. This collision detection shall be described in more detail later.

At a step S508, the game engine 220 determines whether the collision detection module 222 has detected that one or more collisions have occurred.

If the collision detection module 222 has detected that one or more collisions have not occurred, then processing continues at a step S512 at which the image generation module 228 generates image data representing a view on the virtual environment (including the objects located therein). For this, the image generation module 228 will use the deformation mesh data 204 and the graphical data 206 to determine the appearance (shape, texture, colouring, etc.) of the objects appearing in the view on the virtual environment, as has been described above. The image generation module 228 then causes an image to be displayed to the player using the generated image data. Methods for rendering or outputting an image of a virtual environment and its associated virtual objects (e.g. based on displaying a plurality of triangles) are well-known and shall not be described in more detail herein.

If, on the other hand, the collision detection module 222 has detected that one or more collisions have occurred, then processing continues at a step S510 at which the game engine 220 uses the physics engine 224 and the mesh adjustment module 226 to update the appearance of one or more of the objects involved in the collision. This shall be described in more detail later. Processing then continues at the step S512.

Once an image has been displayed at the step S512, then processing returns to the step S504 at which the virtual objects may again be moved within the virtual environment.

The steps S504 to S512 are performed for each of a series of time-points, such that an output image may be provided for each of the series of time-points (such as at a frame-rate of 25 or 30 output images or frames per second).

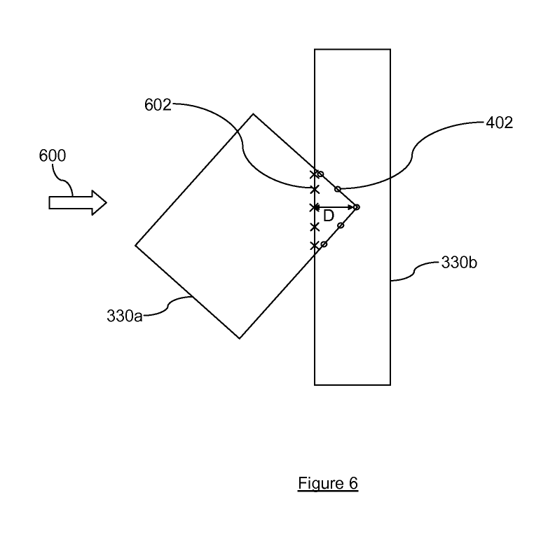

FIG. 6 schematically illustrates (again in two dimensions of clarity, but it will be appreciated that embodiments of the invention operation in three dimensions) a collision and the processing performed by the collision detection module 222. In the collision illustrated in FIG. 6, a first object 330a has been moved at the step S504 of FIG. 5 in the direction of an arrow 600 and, in doing so, has collided with a second object 330b (or item) in the virtual environment of the computer game 108. This second object 330b may be another object that was moved at the step S504 or may be an object that is not moved as part of the computer game 108 (e.g. a virtual wall, building, tree, etc.)

In FIG. 6, a number of vertices 402 of the physical data 202 for the first object 330a are shown (the circles). In particular, in FIG. 6, the vertices 402 that are depicted are ones that overlap with the position or location of the second object 330b, i.e. the depicted vertices 402 are within the volume that is defined by the shape of the second object 330b. These vertices shall be referred to below as the collision vertices. The volume defined by the shape of the second object 330b may be, for example, the volume defined by the shape resulting from the physical data 202 for the second object 330b (when the second object 330b is one that is being moved in the virtual environment and hence has corresponding physical data 202). Alternatively, if, for example, the second object 330b is one that is not moved in the virtual environment during the game (e.g. it is a virtual fixed wall), then the other data 250 stored in the memory 114 may store data defining the position, shape or volume of the second object 330b.

In any case, the collision detection module 222 detects that the first object 330a has collided with the second object 330b by determining whether any of the vertices 402 of the physical data 202 of the first object 330a overlap with the second object 330b, i.e. whether, as a result of moving the first object 330a, one or more of these vertices 402 is now at a position within the second object 330b (i.e. whether any of the vertices 402 have become collision vertices). To do this, the collision detection module 222 may use the physical data 202 to determine the position of the vertices 402 of the physical data 202 relative to the deformation mesh 300 for the first object 330a, and hence determine the position of the vertices 402 in the local coordinate space of the first object 330a. The collision detection module 222 may then use these positions together with the data 210 specifying the orientation and position of the first object 330a in the global coordinate space of the computer game 108 to determine the position of the vertices 402 in the global coordinate space of the computer game 108. The collision detection module 222 may then determine whether any of these positions in the global coordinate space of the computer game 108 overlap (or lie within) the extent or bounds of any other object in the virtual environment (methods for this being well-known and shall not be described in detail herein).

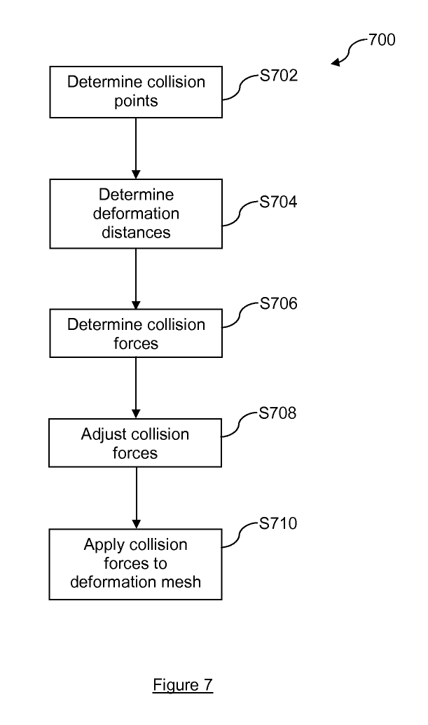

FIG. 7 is a flowchart schematically illustrating a method 700 for updating the appearance of an object 330a at the step S510 of FIG. 5 once a collision has been detected. The method 700 of FIG. 7 shall be described below with reference to the example collision shown in FIG. 6.

At a step S702, the physics engine 224 determines, for each collision vertex 402, a corresponding point (referred to below as a collision point 602) on the surface of the second object 330b that the first object 330a has collided with. The collision point 602 is the point on the surface of the second object 330b at which the corresponding collision vertex 402 would have first touched the surface of the second object 330b as the first object 330a is moved towards the second object 330b in the direction of the arrow 600. The collision points 602 are shown in FIG. 6 as crosses. The location of a collision point 602 will depend on the position of the corresponding collision vertex 402 and the relative direction 600 of travel of the first object 330a and the second object 330b.

At a step S704, the physics engine 224 determines, for each collision vertex 402, the respective distance between that collision vertex 402 and its corresponding collision point 602, which shall be referred to as a deformation distance. In FIG. 6, a deformation distance is illustrated as a distance “D”.

At the step S704, the physics engine 224 may adjust one or more of the determined deformation distances D. In particular, the physics data 202 may store, for one of more of the vertices 402 of the physics data 202, a corresponding threshold T for a deformation distance of that vertex. In some embodiments, this threshold T may be dependent upon the direction away from the vertex 402. In any case, the physics engine 224 may determine whether a collision vertex 402 has a corresponding threshold T, and if so, whether the corresponding deformation distance D exceeds the threshold T (taking into account, where appropriate, the direction from the collision vertex 402 to the corresponding collision point 602), and if so, then the physics engine 224 may set the deformation distance D for that collision vertex 402 to be the corresponding threshold T.

The above optional adjustment of the deformation distances D takes into account the situation in which it is desirable to limit an amount of deformation which is to be applied to the shape of the object 330a. For example, when simulating an object 330a that has a solid section and a hollow section, it may be preferable to limit the available deformation of the solid section in comparison to the available deformation of the hollow section so as to more realistically represent the structure of that object 330a. As a more specific example, if the object 330a represents a car, then the solid section may represent an engine compartment whilst the hollow section may represent the passenger compartment.

At a step S706, the physics engine 224 determines, for each of the collision vertices 402, a corresponding (virtual) force for application at that collision vertex 402. The physics engine 224 determines these forces such that the application of these forces to their respective collision vertices 402 would cause each collision vertex 402 to move by its corresponding deformation distance D towards its corresponding collision location 602. For this, the physics engine 224 uses the rigidity data 208. Methods for calculating such forces are well known and shall not be described in more detail herein.

a step S708, the physics engine 224 may adjust the magnitude of the force corresponding to one or more of the collision vertices 402. For example, if the second object 330b is to remain stationary within the virtual environment, then the physics engine 224 may determine not to adjust the determined forces. However, if the second object 330b is to move as a result of the collision, then the physics engine 224 may determine to reduce one or more of the forces accordingly. Additionally, the physics engine 224 may reduce one or more of the forces in dependence upon the relative speeds and/or weights of the colliding objects 330a, 330b in the virtual environment. For example, if the relative speed S_{R} is above a certain threshold speed S_{T}, then the physics engine 224 may determine not to adjust the determined forces, whereas if the relative speed S_{R} is not above that threshold, then the physics engine 224 may reduce one or more of the forces based on the difference between the threshold speed S_{T} and the relative speed S_{R}

$$( e . g . a force F may be adjusted so as to be come \frac{{S}_{R}}{{S}_{T}} F ) .$$

Similarly, if the weight of the second object 330b is small, then the physics engine 224 may reduce the forces by more than if the weight of the second object 330b were larger.

In this way, for example, the physics engine 224 can distinguish between different collision scenarios and adjust the deformation of the shape of the object 330a accordingly, such as example scenarios of: (a) a virtual car 330a colliding with an immovable wall 330b at high speed (requiring large deformation and large forces); (b) a virtual car 330a colliding with an immovable wall 330b at low speed (requiring small deformation and small forces); (c) a virtual car 330a colliding with a movable light cone 330b at high speed (requiring a small to medium deformation and small to medium forces); (d) a virtual car 330a colliding with a movable light cone 330b at low speed (requiring no deformation and no forces); (e) a virtual car 330a colliding with another heavy movable car 330b at high speed (requiring a large deformation and large forces); and (f) a virtual car 330a colliding with another heavy movable car 330b at low speed (requiring small to medium deformation and small to medium forces).

It will be appreciated that embodiments of the invention may adjust the collision forces that have been determined in a number of ways to try to more realistically model and represent a collision, based on the particular properties of the objects 330a, 30b involved in the collision and the circumstances/dynamics of the collision.

At a step S710, the mesh adjustment module 226 applies the determined forces to the deformation mesh 300 for the object 330a. The mesh adjustment module 226 uses the rigidity data 208 for the object 330a to determine how to move one or more of the nodes 302 of the deformation mesh 300 due to the application of the determined forces at the locations of the one or more collision vertices 402. Methods for calculating the respective movements of the nodes 302 are well known and shall not be described in more detail herein.

### Multiple Sets of Graphical Data

In some embodiments, the game data 200 for an object 330 may comprise a plurality of sets of graphical data 206. One of these is a default set of graphical data 206 which the game engine 220 uses at the beginning of a game. The sets of graphical data 206 may store, for one or more of the vertices 402 of that set of graphical data 206, a corresponding maximal deformation distance. Then, at the step S710, when the mesh adjustment module 226 deforms the deformation mesh 300, the mesh adjustment module 226 may determine, for each of the vertices 402 of the currently used set of graphical data 206 that have a corresponding maximal deformation distance, whether that vertex 402 is now further than its maximal deformation distance away from its original position (before any adjustments to the deformation mesh 300 have been applied). If this happens, then the game engine 220 may select a different set of graphical data 206 to use instead of the current set of graphical data 206. In this way, further adjustments to the appearance of the object 330 may be implemented when various points on the surface of the object 330 have been moved beyond a threshold distance (due to a collision). The additional sets of graphical data 206 may be used, for example, to provide additional visual modifications to the appearance of an object 330, for example separating seams and bending panels of a virtual car 330. Typically, such additional modifications do not significantly affect the overall shape of the object 330, so preferred embodiments use a single set of physical data 202 but have multiple sets of graphical data 206 to choose from depending on the extent of the deformation of the deformation mesh 300.

Additionally, in some embodiments, the game engine 220, rather than simply selecting an alternative set of graphical data 206 and using that set of graphical data 206 instead of the current set of graphical data 206, may blend the current set of graphical data 206 and the alternative set of graphical data 206 to form an “intermediate” set of graphical data 206 for use to display an image of the object 330 instead. This blending may be performed by interpolating between the two sets of graphical data 206 at each vertex 402 of the graphical data 206 based on the distance that that vertex 402 has moved from its original (undeformed) position. For example, with a vertex 402 that has a maximal deformation distance, then if that vertex 402 has not moved from its original position, then the interpolation would result in using just the current (original) graphical data 206, whereas if that vertex 402 has moved by at least the maximal deformation distance, then the interpolation would result in using just the alternative graphical data 206, and if that vertex 402 has moved a proportion of the way towards the maximal deformation distance, then the interpolation would linearly weight the contributions from the sets of graphical data 206 according to that proportion.

### Textures

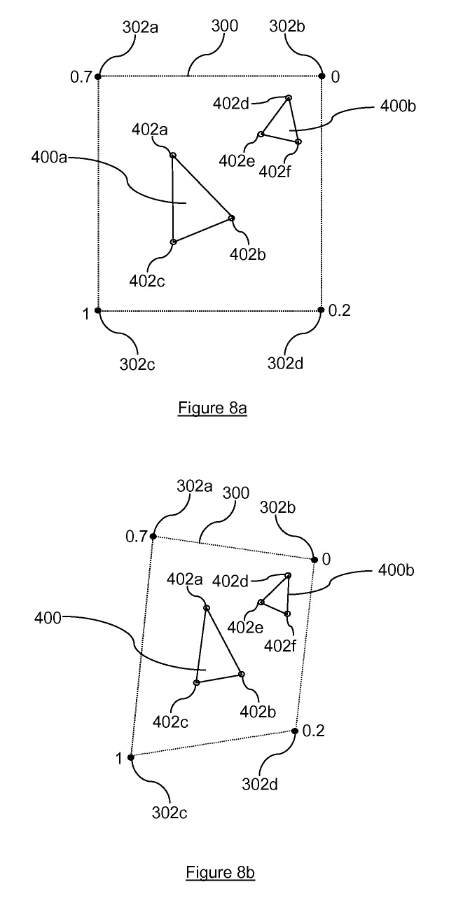

In some embodiments, the deformation mesh data 204 may store, for each of the nodes 302 of the deformation mesh 300, a corresponding texture value. FIG. 8a schematically illustrates a part of the deformation mesh 300 (with nodes 302a, 302b, 302c, 302b) and two triangles 400a, 400b of the graphical data 206 and their respective vertices 402a, 402b, 402c, 402d, 402e, 402f. FIG. 8b schematically illustrates the same part of the deformation mesh 300 of FIG. 8a after the deformation mesh 300 has undergone a deformation.

As illustrated in FIGS. 8a and 8b, the nodes 302 of the deformation mesh 300 each have an associated texture value: the texture value for the node 302a is 0.7; the texture value for the node 302b is 0; the texture value for the node 302c is 1; and the texture value for the node 302d is 0.2. However, it will be appreciated that the texture value of a node 302 may be any value. The game engine 200 may be arranged to update the texture values. For example, the texture value for a node 302 may be dependent (e.g. proportional) to the displacement of that node 302 from its original position in the initialised deformation mesh 300 or may be dependent upon a type of collision (e.g. based on detecting a “scrap” or a “scratch”).

The image generation module 228, when generating the image data for the output image to be displayed to the player at the step S512, may generate a corresponding texture value for each of the vertices 402 of the graphical data 206, for example, by interpolating the texture values of two or more neighbouring nodes 302 of the deformation mesh 300 (this being done in an analogous manner to the above-described procedure in which the position of the vertex 402 may be determined by interpolating the positions of two or more neighbouring nodes 302). Then, when generating the image data for the output image, the image generation module 228 may apply a texture to a triangle 400 of the graphical data 206 in accordance with the texture values of the vertices 402 of that triangle 400 (as it well-known in this field of technology).

In the example shown in FIGS. 8a and 8b, the vertices 402a, 402b, 402c of the first triangle 400a will receive a larger texture value than the vertices 402d, 402e, 402f of the second triangle 400b due to their positions relative to the neighbouring nodes 302a, 302b, 302c, 302d and the current texture values of those nodes. Hence, when an image is generated using these triangles 400a, 400b, the first triangle 400a will have more texture applied to it than the second triangle 400b.

For example, in a car-racing genre game, the object 330 could represent a vehicle and the texture could represent a scratch on the surface of the vehicle. In this case, the texture values could range from a minimum value (e.g. 0) representing no scratches up to a maximum value (e.g. 1) representing a highest degree of scratches.

### Compound Objects

The computer game 108 may make use of a compound object, which is an association of a plurality of separate objects 330. These separate objects 330 each have their own game data 200, which is processed and updated as has been described above. The movements of these separate objects 330 in the virtual environment are linked to each other, i.e. the separate objects 330 are considered to be connected to each other, but not necessarily rigidly or fixedly connected to each other in that one separate object 330 may pivot or swing or rotate around another one of the separate objects 330.

For example, in a car-racing genre game, a vehicle may be represented as a compound object that comprises separate objects 330 representing windows, body panels, bumpers (fenders) and wheels. In this way, different textures may be applied to different parts of the vehicle (e.g. windows may crack or shatter, whilst body panels may scratch). Additionally, panels or bumpers may begin to become detached from the vehicle (e.g. a swinging bumper may be implemented, in which the bumper object 330 moves along with the rest of the separate objects 330, but its local coordinate system rotates with respect to the local coordinate system of the rest of the separate objects 330). The game engine 220 may determine that a body part is to become detached from the vehicle, in which case the association of the corresponding separate object 330 with the other separate objects 330 is removed or cancelled.

### Slow-Motion Playback or Replay of a Collision

In some embodiments, the computer game 108 is arranged such that the game engine 200 will, after a collision has occurred, display to the user a slow-motion replay of that collision. This involves generating and outputting a number of output images corresponding to time-points between the images that were output at the step S512 as part of the normal processing 500. For example, the step S512 may output an image every 1/30 or 1/25 of a second during the game play. However, in the slow-motion replay of a collision, the playback may be slowed down by a factor α (e.g. 10) and an image may be generated to represent the status of the virtual environment during the collision at every 1/(30α) or 1/(25α) of a second of the collision (with these images then being output every 1/30 or 1/25 of a second).

To do this, the game engine 220 stores, for each object 330, a copy of the deformation mesh data 206 for that object 330 prior to moving that object at the step S504. Thus, when a collision has occurred, the game engine 220 has available to it a copy of the deformation mesh data 206 representing the deformation mesh 300 before the collision, and a copy of the deformation mesh data 206 representing the deformation mesh 300 after the collision.

The game engine 220 is therefore able to determine the coordinates of a vertex 402 of the graphical data 206 for the frame before a collision (using the deformation mesh 300 before the collision) as well as the coordinates of that vertex 402 for the frame after the collision (using the deformation mesh 300 after the collision). With this, it would then be possible to interpolate the positions of the vertices of the graphical data 206 to generate an intermediate shape for the object 330 at time-points lying between the time point of the frame immediately before the collision occurred and time point of the frame when the collision occurred. The slow-motion replay of a collision may then be generated using the interpolated positions. However, doing this often leads to a visually unacceptable replay, as a deformation of an object 330 may appear to start before or after the collision itself actually takes place.

Thus, embodiments of the invention may also determine, when a collision has occurred, (a) the relative speed S_{R} of the objects 330 involved in the collision and (b) the above-identified deformation distances D for the collision vertices 402. The time point between the time point T_{C} of the current frame (involving the collision) and the time point T_{P} of the previous frame (just prior to the collision) at which the collision actually occurred for a collision vertex 402 may then be determined as T_{Col}=T_{c}−D/S_{R}. Thus, the game engine 220 may determine the time point T_{FCol} at which the objects 330 first collided (i.e. when the collision started or, put another way, when a point on the object 330a first impacted on the other object 330b involved in the collision). One way to do this is to ascertain the largest of the above-identified deformation distances (D_{Largest}) for the various collision vertices 402 of the object 330 and then calculate T_{FCol} using this largest deformation distance, as T_{FCol}=T_{c}−D_{Largest}/S_{R}. Alternatively, embodiments of the invention may simply determined the smallest value of T_{Col} out of all of the values of T_{Col} for the various collision vertices 402.

Then, in the slow-motion replay, embodiments of the invention may interpolate between the pre-collision deformation mesh 300 and the post-collision deformation mesh 300. This interpolation commences at the respective slow-motion replay frame at which it is determined that the collision has first occurred (i.e. at which the collision started). In other words, for slow-motion time points before T_{FCol}, no interpolation is used and the copy of the deformation mesh data 206 for prior to the collision is used. For slow-motion time points between T_{FCol} and T_{C}, the game engine 220 interpolates between the deformation mesh data 206 pre-collision and the deformation mesh data 206 post-collision to form respective intermediate positions of the nodes 302 and corresponding intermediate deformation meshes 300 so that an intermediate level of deformation during the collision can be generated and presented during the slow-motion play back. This provides a more realistic slow-motion replay of a collision.

### Alternatives

In the above description, the graphical data 206 and physical data 202 have been described as storing the locations of vertices of triangles, where the triangles form a surface of a shape for the corresponding object 330. However, it will be appreciated that the points (or locations) identified by the graphical data 206 and physical data 202 need not be vertices of triangles, and that a shape for the object 330 may be determined from the plurality of locations identified by the graphical data 206 and physical data 202 in any other way (e.g. by curve or surface fitting algorithms).

It will be appreciated that embodiments of the invention may be implemented using a variety of different information processing systems. In particular, although FIG. 1 and the discussion thereof provide an exemplary computing architecture and games console, these are presented merely to provide a useful reference in discussing various aspects of the invention. Of course, the description of the architecture has been simplified for purposes of discussion, and it is just one of many different types of architecture that may be used for embodiments of the invention. It will be appreciated that the boundaries between logic blocks are merely illustrative and that alternative embodiments may merge logic blocks or elements, or may impose an alternate decomposition of functionality upon various logic blocks or elements.

As described above, the system 100 comprises a games console 102. The games console 102 may be a dedicated games console specifically manufactured for executing computer games. However, it will be appreciated that the system 100 may comprise an alternative device, instead of the games console 102, for carrying out embodiments of the invention. For example, instead of the games console 102, other types of computer system may be used, such as a personal computer system, mainframes, minicomputers, servers, workstations, notepads, personal digital assistants, and mobile telephones.

It will be appreciated that, insofar as embodiments of the invention are implemented by a computer program, then a storage medium and a transmission medium carrying the computer program form aspects of the invention. The computer program may have one or more program instructions, or program code, which, when executed by a computer carries out an embodiment of the invention. The term “program,” as used herein, may be a sequence of instructions designed for execution on a computer system, and may include a subroutine, a function, a procedure, an object method, an object implementation, an executable application, an applet, a servlet, source code, object code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a BluRay disc), or a memory (such as a ROM, a RAM, EEPROM, EPROM, Flash memory or a portable/removable memory device), etc. The transmission medium may be a communications signal, a data broadcast, a communications link between two or more computers, etc.

1. A method of controlling the appearance of an object in a virtual environment of a computer game, in which the computer game is arranged to move the object within the virtual environment, the method comprising:
associating with the object a three-dimensional array of nodes by storing, for each node, data defining a position of that node in a coordinate system for the object;
defining a first shape of the object by associating each of a first plurality of locations on the object with a respective predetermined position relative to one or more of the nodes;
detecting a collision of the object with an item in the virtual environment;
adjusting the position of one or more of the nodes to represent the collision, thereby adjusting the first shape of the object; and
outputting an image of the object based on the adjusted first shape of the object.

2. A method according to claim 1, in which the first plurality of locations on the object are vertices of respective triangles that define a surface of the object.

3. A method according to claim 1, comprising defining a second shape of the object by associating each of a second plurality of locations on the object with a respective predetermined position relative to one or more of the nodes; wherein detecting a collision of the object with an item comprises detecting that one or more of the second plurality of locations lies within the item.

4. A method according to claim 3, in which the second plurality of locations has fewer locations than the first plurality of locations.

5. A method according to claim 3, wherein adjusting the position of one or more of the nodes to represent the collision comprises simulating applying one or more respective forces at the one or more of the second plurality of locations that lie within the item.

6. A method according to claim 5, comprising:
storing rigidity data representing a degree of elasticity between the nodes; and
calculating the one or more forces based, at least in part, on the rigidity data.

7. A method according to claim 6, comprising determining, for each of the one or more of the second plurality of locations that lie within the item, a respective depth that that location is within the item, wherein calculating the one or more forces is based, at least in part, on the respective depths.

8. A method according to claim 7, comprising, for at least one of the one or more of the second plurality of locations that lie within the item, setting the respective depth for that location to a predetermined threshold depth associated with that location if the determined depth exceeds that threshold depth.

9. A method according to claim 6, comprising determining the one or more forces based, at least in part, on a relative speed between the object and the item.

10. A method according to claim 1 comprising:
defining a second shape of the object by associating each of a second plurality of locations on the object with a respective predetermined position relative to one or more of the nodes, such that adjusting the position of one or more of the nodes to represent the collision results in adjusting the second shape of the object;
detecting whether, as a result of adjusting the position of one or more of the nodes to represent the collision, a predetermined one of the first plurality of locations has been displaced by more than a threshold distance; and
if that predetermined one of the first plurality of locations has been displaced by more than the threshold distance, then outputting the image of the object based on the adjusted second shape of the object instead of the adjusted first shape of the object.

11. A method according to claim 1, comprising associating with each of the nodes a respective texture value representing a degree of texture for that node; wherein outputting the image of the object comprises applying a texture to a surface of the object based on the texture values.

12. A method of executing a computer game, the method comprising carrying out the method of claim 1 at each time point of a first sequence of time points.

13. A method according to claim 12, the method comprising, after the collision has been detected, displaying a sequence of images of the object, each image corresponding to a respective time point of a second sequence of time points, the time difference between successive time points of the second sequence of time points being smaller than the time difference between successive time points of the first sequence of time points, by:
determining a point in time at which the collision occurred;
for each time point of the second sequence of time points that precedes the determined point in time, using the positions of the nodes prior to the collision to determine a shape of the object for display;
for each time point of the second sequence of time points between the determined point in time and the time point of the first sequence of time points at which the collision is detected, interpolating between the positions of the nodes prior to the collision and the adjusted positions of the nodes to determine intermediate positions of the nodes to determine a respective shape of the object for display.

14. An apparatus arranged to execute a computer game and control the appearance of an object in a virtual environment of the computer game, in which the computer game is arranged to move the object within the virtual environment, the apparatus comprising:
a memory storing:
(a) data associating with the object a three-dimensional array of nodes, the data comprising, for each node, data defining a position of that node in a coordinate system for the object; and
(b) data defining a first shape of the object by associating each of a first plurality of locations on the object with a respective predetermined position relative to one or more of the nodes; and
a processor comprising:
a collision detection module for detecting a collision of the object with an item in the virtual environment;
an adjustment module for adjusting the position of one or more of the nodes to represent the collision, thereby adjusting the first shape of the object; and
an image output module for outputting an image of the object based on the adjusted first shape of the object.

15. A computer readable medium storing a computer program which, when executed by a computer, carries out a method according to claim 1.
